(19) United States
(12) Patent Application Publication
(10) Pub. No.: US 2025/0023365 A1
(43) Pub. Date: Jan. 16, 2025

(54) CHARGING PARALLEL CONNECTED MIXED-CHEMISTRY ENERGY STORAGE DEVICES

(71) Applicant: GM Global Technology Operations LLC, Detroit, MI (US)

(72) Inventors: Shuonan Xu, Troy, MI (US); Yue-Yun Wang, Troy, MI (US); Lei Hao, Troy, MI (US); Jun-mo Kang, Ann Arbor, MI (US); Su-Yang Shieh, Clawson, MI (US); Mohamed Kamel, Birmingham, MI (US)

(21) Appl. No.: 18/352,316

(22) Filed: Jul. 14, 2023

(51) Int. Cl. H02J 7/00; B60L 53/10; H02J 7/34

(52) U.S. Cl. CPC H02J 7/0013; B60L 53/11; H02J 7/00714; H02J 7/342; B60L 2210/10

(57) ABSTRACT

Simultaneous parallel charging of a first and second electrical energy storage devices coupled to a charge source is carried out by directly coupling the charge source to one of the first ESD and the second ESD and through a DC to DC converter to the other of the first ESD and the second ESD. The charge source provides a current that is allocated to the two ESDs by controlling the DC to DC converter. Priority of charging may be given to either ESD.

### INTRODUCTION

Electrified vehicles may have one or more rechargeable energy storage systems including multiple energy storage devices including battery packs and supercapacitors. The energy storage devices may have different characteristics and charge requirements owing to different storage technologies, different chemistries, different nominal and dynamic parameters and states. Electrified vehicles may have standardized recharging ports for interfacing with charge infrastructure. Such charge infrastructure has limited flexibility in charge profile availability, thus presenting challenges to charging energy storage devices with different charge requirements. Simultaneous recharging of multiple energy storage devices having different charge requirements is desirable.

### SUMMARY

In one exemplary embodiment, a method of controlling simultaneous parallel charging of a first electrical energy storage devices (ESD) and a second ESD from a charge source may include coupling the charge source directly to one of the first ESD and the second ESD and through a direct current to direct current (DC to DC) converter to the other of the first ESD and the second ESD, determining a first current for charging the first ESD and determining a second current for charging the second ESD. When the charge source cannot simultaneously provide the first current and the second current without violating a charge source constraint, determining a reduced second current for charging the second ESD wherein the charge source can simultaneously provide the first current and the reduced second current without violating the charge source constraint. Allocating the first current to the first ESD and the reduced second current to the second ESD is effected by controlling the DC to DC converter.

In addition to one or more of the features described herein, the charge source may be coupled directly to the first ESD and through the DC to DC converter to the second ESD.

In addition to one or more of the features described herein, the charge source may be coupled directly to the second ESD and through the DC to DC converter to the first ESD.

In another exemplary embodiment, a charge apparatus for a rechargeable energy storage system (RESS) may include a charge source, a DC to DC converter, a first energy storage device (ESD), and a second ESD wherein the charge source coupled directly to one of the first ESD and the second ESD and through the DC to DC converter to the other of the first ESD and the second ESD. A controller determines a first current for charging the first ESD and determines a second current for charging the second ESD. When the charge source cannot simultaneously provide the first current and the second current without violating a charge source constraint, the controller determines a reduced second current for charging the second ESD wherein the charge source can simultaneously provide the first current and the reduced second current without violating the charge source constraint, and allocates the first current to the first ESD and the reduced second current to the second ESD by controlling the DC to DC converter.

In addition to one or more of the features described herein, the charge source may include an infrastructure charge station.

In addition to one or more of the features described herein, the charge source may include a donor vehicle.

In addition to one or more of the features described herein, the first ESD and the second ESD may include batteries.

In addition to one or more of the features described herein, at least one of the first ESD and the second ESD may include a supercapacitor.

In addition to one or more of the features described herein, the DC to DC converter may include a boost converter.

In addition to one or more of the features described herein, the DC to DC converter may include a buck converter.

In addition to one or more of the features described herein, the DC to DC converter may include a buck/boost converter.

In addition to one or more of the features described herein, the charge source may be coupled directly to the first ESD and through the DC to DC converter to the second ESD.

In addition to one or more of the features described herein, the charge source may be coupled directly to the second ESD and through the DC to DC converter to the first ESD.

In yet another exemplary embodiment, an electrified powertrain for a vehicle may include a rechargeable energy storage system (RESS) including a first energy storage device (ESD) and a second ESD, an electric drive unit (EDU), a DC to DC converter, and a controller determining a first current for charging the first ESD and determining a second current for charging the second ESD. When a charge source that is coupled directly to one of the first ESD and the second ESD and through the DC to DC converter to the other of the first ESD and the second ESD cannot simultaneously provide the first current and the second current without violating a charge source constraint, the controller determines a reduced second current for charging the second ESD wherein the charge source can simultaneously provide the first current and the reduced second current without violating the charge source constraint, and allocates the first current to the first ESD and the reduced second current to the second ESD by controlling the DC to DC converter.

In addition to one or more of the features described herein, the first ESD and the second ESD may include batteries.

In addition to one or more of the features described herein, at least one of the first ESD and the second ESD may include a supercapacitor.

In addition to one or more of the features described herein, the DC to DC converter may include one of a boost converter and a buck converter.

In addition to one or more of the features described herein, the DC to DC converter may include a buck/boost converter.

In addition to one or more of the features described herein, the charge source may be coupled directly to the first ESD and through the DC to DC converter to the second ESD.

In addition to one or more of the features described herein, the charge source is coupled directly to the second ESD and through the DC to DC converter to the first ESD.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 illustrates an electric propulsion system on a vehicle, in accordance with one or more embodiments;

FIG. 2 illustrates an exemplary charging configuration, in accordance with one or more embodiments;

FIG. 3 illustrates an exemplary charging control, corresponding to the charging configuration of FIG. 2, in accordance with one or more embodiments;

FIG. 4 illustrates an exemplary charge control routine, in accordance with one or more embodiments; and

FIG. 5 illustrates an exemplary charge control routine, in accordance with one or more embodiments.

### DETAILED DESCRIPTION

The following description is merely exemplary in nature and is not intended to limit the present disclosure, its application or uses. Throughout the drawings, corresponding reference labels indicate like or corresponding parts and features. Description of parts and features in one drawing is understood to apply to parts and features in other drawings sharing the same reference labels to the extent such parts and features are not otherwise distinguishable through drawing examination by one having ordinary skill in the art or distinguished by additional written description herein.

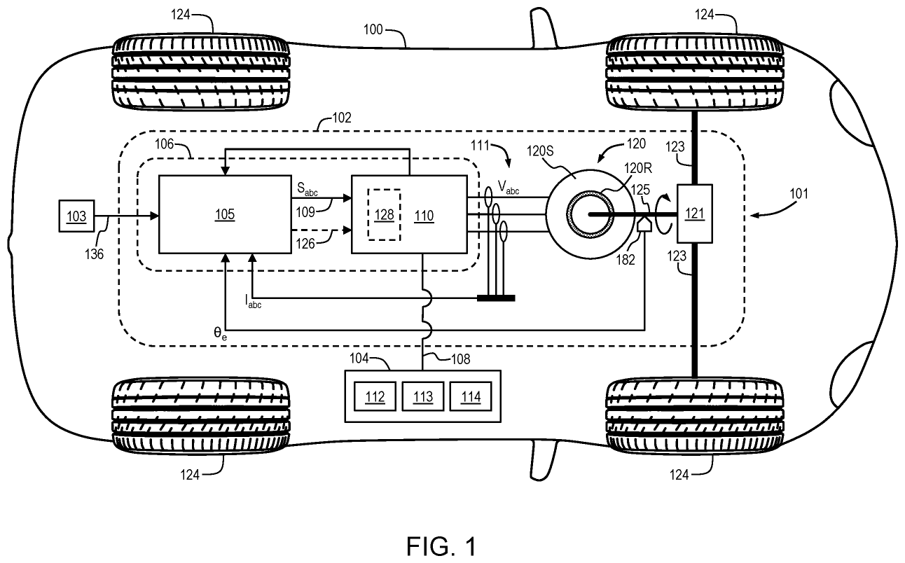

FIG. 1 schematically illustrates an embodiment of an electric propulsion system 101 on an electrified vehicle 100. Vehicle and vehicular are understood to refer to any means of transportation including non-limiting examples of motorcycles, cars, trucks, buses, excavation, earth moving, construction and farming equipment, railed vehicles like trains and trams, and watercraft like ships and boats. The electric propulsion system 101 may include various control components, electrical systems and electro-mechanical systems including, for example, a rechargeable energy storage system (RESS) 104 and an electric drive unit (EDU) 102. The electric propulsion system 101 may be employed on a powertrain system to generate propulsion torque as a replacement for, or in conjunction with, an internal combustion engine in various electric vehicle (EV) applications and hybrid electric vehicle (HEV) applications, respectively.

The EDU 102 may be of varying complexity, componentry and integration. An exemplary highly integrated EDU 102 may include, for example, a rotary electric machine such as an alternating current (AC) motor (motor) 120 and a traction power inverter module (TPIM) 106 including a motor controller 105 and a power inverter 110. The motor 120 may include a stator 120S and a rotor 120R coupled to a rotor shaft 125 and position sensor 182, for example a variable reluctance resolver or an encoder. The position sensor 182 may signally connect directly to the motor controller 105 and is employed to monitor angular position (De) of the rotor of the motor 120. The angular position (0e) of the rotor of the motor 120 is employed by the motor controller 105 to control operation of the power inverter 110 that controls torque production and other functions of the motor 120, including through the first derivative quantity of angular speed (i.e., motor speed).

The rotor shaft 125 may transfer torque between the motor 120 and driveline components, some of which may be integrated within the EDU 102, for example in a gearbox 121 including reduction and differential gear sets and one or more axle outputs. The gearbox 121 may simply include reduction gearing and a prop shaft output for coupling to a differential gear set. One or more axles 123 may couple to the gearbox 121 directly or through final drive or differential gear sets if separate therefrom. Axle(s) 123 may couple to one or more vehicle wheel(s) 124 for transferring tractive force between a wheel and pavement. One having ordinary skill in the art will recognize alternative arrangements for driveline components. Propulsion torque requests or commands 136 (T_{cmd}) may be provided by a vehicle controller 103 to the motor controller 105 as a discrete input over a network bus such as a CAN bus.

Any controller may include one or more control modules. As used herein, control module, module, control, controller, control unit, electronic control unit, processor and similar terms mean any one or various combinations of one or more of Application Specific Integrated Circuit(s) (ASIC), electronic circuit(s), central processing unit(s) (preferably microprocessor(s)) and associated memory and storage (read only memory (ROM), random access memory (RAM), electrically programmable read only memory (EPROM), hard drive, etc.) or microcontrollers executing one or more software or firmware programs or routines, combinational logic circuit(s), input/output circuitry and devices (I/O) and appropriate signal conditioning and buffer circuitry, high speed clock, analog to digital (A/D) and digital to analog (D/A) circuitry and other components to provide the described functionality. A control module may include a variety of communication interfaces including point-to-point or discrete lines and wired or wireless interfaces to networks including wide and local area networks, a controller area network (CAN) bus, and in-plant and service-related networks including for over the air (OTA) software updates. Functions of a control module as set forth in this disclosure may be performed in a distributed control architecture among several networked control modules. Software, firmware, programs, instructions, routines, code, algorithms and similar terms mean any controller executable instruction sets including calibrations, data structures, and look-up tables. A control module may have a set of control routines executed to provide described functions. Routines are executed, such as by a central processing unit, and are operable to monitor inputs from sensing devices and other networked control modules and execute control and diagnostic routines to control operation of actuators. Routines may be executed at regular intervals during ongoing engine and vehicle operation. Alternatively, routines may be executed in response to occurrence of an event, software calls, or on demand via user interface inputs or requests.

The RESS 104 may, in one embodiment, include one or more electrical energy storage devices such as electro-chemical battery packs 112, for example high capacity, high voltage (HV) rechargeable lithium ion battery packs for providing power to the vehicle via a HV direct current (DC) bus 108. The RESS 104 may include one or more battery packs 112 constructed from a plurality of battery pack modules allowing for flexibility in configurations and adaptation to application requirements. Battery packs may include a plurality of battery pack modules constructed from a plurality of cells allowing for flexibility in configurations and adaptation to application requirements. Battery pack modules may include a plurality of cells allowing for flexibility in configurations and adaptation to application requirements. For example, in vehicular uses, the RESS 104 may be modular to the extent that the number of battery pack modules may be varied to accommodate a desired energy density or range objective of a particular vehicle platform, intended use, or cost target. Battery packs and battery pack modules may be variously and selectively configured in accordance with desired propulsion architecture and charging and discharging functions, for example through controllable switching devices such as HV solid state relays and electromechanical contactors for establishing various connections and disconnections including battery pack and module disconnections and reconfigurations. It is understood that the RESS 104 may be reconfigurable at any level of integration including battery pack, battery module and cell. In an embodiment, the RESS may be selectively configured to provide the HV direct current (DC) bus 108 with two or more voltage levels, for example 800 volts and 400 volts, for propulsion, charging or other purposes. Moreover, the RESS 104 may include combinations of battery packs 112 of different chemistries, capacities, performance and other characteristics. In other embodiments, the RESS may include combinations of different electrical energy storage device technologies such as battery packs 112 and super-capacitors. The RESS 104 may include a DC to DC converter (converter) 113 and a battery manager module 114 which may include an on-board charging module (OBCM) and a DC to DC converter control module (CCM) as described further herein.

The motor 120 may be a multi-phase AC motor receiving multi-phase AC power over a multi-phase power bus (AC bus) 111 which is coupled to the power inverter 110. In one embodiment, the motor 120 is a three-phase motor and the power inverter 110 is a three-phase inverter. The power inverter 110 may include a plurality of solid-state switches in a solid-state switching section. The power inverter 110 couples to DC power over the HV DC bus 108 (DC input voltage (V_{dc})) from the RESS 104, for example selectively at 400 or 800 volts via electromechanical contactors for establishing various connections and disconnections including battery pack and module disconnections and reconfigurations. The voltage level of the HV DC bus 108 may be selected, established or otherwise set by the battery manager module 114 as may be requested by the motor controller 105. The HV DC bus 108 may be referred to as a DC link and the voltage level of the HV DC bus may be referred to as the DC link voltage. The motor controller 105 is coupled to the power inverter 110 for control thereof. The power inverter 110 electrically connects to stator phase windings of a three-phase stator winding of the motor 120 via the AC bus 111, with electric current (I_{abc}) monitored on two or three phases thereof. The AC bus 111 provides conductive coupling of the multi-phase outputs of the power inverter 110 to phase terminals of the stator windings. The AC bus 111 may include AC bus features of the TPIM 106, AC bus features of the motor 120 and conductors connecting the AC bus features of the TPIM 106 and the AC bus features of the motor 120. As used herein, AC bus 111 includes all high voltage/high current phase conductors between the switching section of the power inverter 110 and the motor 120 including, for example, bus bars, cables, rods etc. The power inverter 110 may be configured with suitable control circuits including paired power transistors (e.g., IGBTs) for transforming high-voltage DC voltage on the HV DC bus 108 to high-voltage three-phase AC voltage (V_{abc}) on the AC bus 111 and transforming high-voltage three-phase AC voltage (V_{abc}) on the AC bus 111 to high-voltage DC voltage on the HV DC bus 108. The power inverter 110 may selectively employ any suitable pulse width modulation (PWM) scheme, for example sinusoidal pulse width modulation (SPWM) or other continuous pulse width modulation (CPWM), space vector pulse width modulation (SVPWM) or other discontinuous pulse width modulation (DPWM) including generalized discontinuous pulse width modulation (GDPWM) as well as adaptive (APWM), variable frequency (VFPWM), fractional duty (FDPWM) pulse width modulation variants and others to generate switching vector signals (S_{abc}) 109 to convert stored DC electric power originating in the battery packs 112 of the RESS 104 to AC electric power to drive the motor 120 to generate torque. The PWM scheme may be selected, established or otherwise set by the motor controller. Similarly, the power inverter 110 may convert mechanical power transferred to the motor 120 to DC electric power to generate electric energy that is storable in the battery packs 112 of the RESS 104, including as part of a regenerative braking control strategy. The power inverter 110 may be configured to receive the switching vector signals (S_{abc}) 109 from motor controller 105 and control inverter states to provide the motor drive and regeneration functionality. Switching vector signals (S_{abc}) 109 may also be referred to herein as conduction commands and are understood to inherently include the power inverter switching frequency (FSW) which may be selected, established or otherwise set by the motor controller 105. Other control signals may be provided from and to the motor controller 105, including for example an inverter gate drive parameter control signal 126 to select, establish or otherwise set slew rate, gate drive resistance, or other inverter gate drive parameter in a gate drive module 128 of the power inverter 110 for controlling the switching section of the power inverter 110.

Control of the power inverter 110 may include high frequency switching of the solid-state switches in accordance with the PWM control. A number of design and application considerations and limitations determine inverter switching frequency and PWM control. Inverter controls for AC motor applications may include fixed switching frequencies, for example switching frequencies around 10-30 kHz and PWM controls that minimize switching losses of the IGBTs or other power switches of the power inverter 110. Higher switching frequencies may be achievable with emerging solid-state switching technologies such as silicon carbide (SiC) MOSFETs, gallium nitride (GaN) transistors, diamond MOSFETs, carbon nano-tube transistors, and graphene-based transistors.

The disclosed improvements relate to methods and apparatus for charge management of the electrical energy storage devices of the RESS 104. More particularly, the improvements relate to the simultaneous charging of parallel configurations of electrical energy storage devices of the RESS 104 having different chemistries, capacities, performance and other characteristics, and may be realized in HEV and EV embodiments of the electrified vehicle 100 without limitation, as well as in non-vehicular applications such as power plants, centralized or distributed stationary energy storage applications, etc.

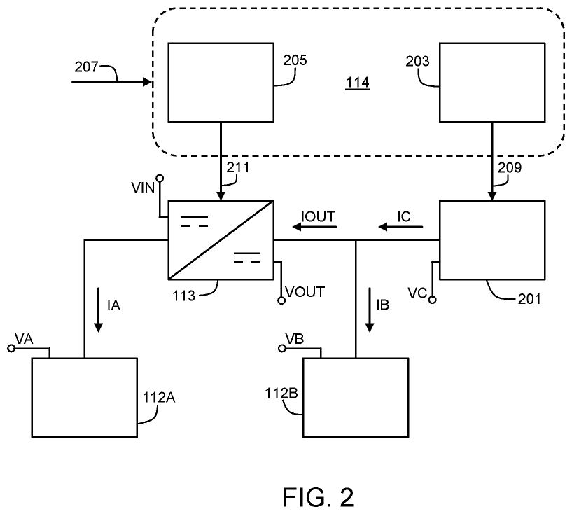

With further reference to FIG. 2, an exemplary embodiment employing battery packs 112 is illustrated. The battery packs 112 of the RESS 104 may include a pack-A 112A and a pack-B 112B. Pack-A 112A and a pack-B 112B may be of the same family, for example lithium-ion, but differ in chemical compositions. Pack-A 112A and a pack-B 112B may be of different families, for example lithium-ion, lithium-sulfur, nickel-metal hydride, lead acid, solid-state, etc. Pack-A 112A and a pack-B 112B may be designed for different objectives. For example, pack-A 112A may have specific energy characteristics making it advantageous as an energy pack, whereas pack-B 112B may have specific power characteristics making it advantageous as a power pack. Such mixed-chemistry battery packs may have different open circuit voltage (OCV) (i.e., terminal voltage), different charging C-rate limits, different SOC at charge time and during charge, and other different characteristics making unmanaged, simultaneous parallel charging infeasible.

In this regard, in accordance with an embodiment, an apparatus for simultaneous parallel charging of pack-A 112A and pack-B 112B as described is set forth herein. It is understood that pack-A and pack-B are merely exemplary, both being batteries; however, as alluded to herein, different electrical energy storage device technologies such as batteries and super-capacitors may make up pack-A and pack-B. As depicted in FIG. 2, pack-A 112A and pack-B 112B are coupled by converter 113. The converter 113 may be any suitable topology and may be design dependent upon the characteristics of pack-A and pack-B and application. The converter 113 may, for example, be operable as a boost converter, a buck converter or a buck/boost converter, may be isolated or non-isolated, and uni-directional or bi-directional. Moreover, the converter 113 may be single or multi-phase as may be advantageous in high power applications and adaptable for adding and shedding phases as may be advantageous in variable power conversion scenarios. As depicted in FIG. 2, the charge station 201 provides a charge station current IC at charge station voltage VC, pack-B receives pack-B current IB at pack-B voltage VB and the converter 113 receives the converter input current IOUT at the converter input voltage VOUT. It is appreciated in the configuration depicted in FIG. 2 that IC=IOUT+IB and VOUT=VC=VB. The converter 113 converts the converter input current IOUT at the converter input voltage VOUT to pack-A current IA at the converter output voltage VIN. Pack-A receives pack-A current IA at pack-A voltage VA. It is appreciated in the configuration depicted in FIG. 2 that VIN=VA. Neglecting operational power losses through the converter 113, it is appreciated that the converter input power is substantially equivalent to the converter output power (i.e., IOUT×VOUT=IA×VIN).

A charge station 201 may be coupled to pack-B 112B as depicted. The charge station 201 may be an off-vehicle power source such as an infrastructure charge station, or another vehicle adapted for charge sharing (e.g., donor vehicle) or may include on-vehicle AC to DC power conversion hardware. The charge station 201 may deliver low power AC (e.g., Level 1, Level 2) relying upon on-board AC to DC conversion or may deliver high power DC (Level 3+) such as a DC fast charge (DCFC) station. In an embodiment, the charge station 201 may be a DCFC station substantially matched to pack-B 112B nominal voltage requirements (e.g., 400 or 800 volts charge station to 400 or 800 volts pack-B). The charge station may be connected to the electrified vehicle 100 through one or more charge ports capable of DC-DC power transfer, for example through CCS, CHAdeMO, or other DC-DC capable connector protocol or standard, which may include wired communications between the electrified vehicle 100 and the charge station 201.

The battery manager module 114 may include the OBCM 203 and the CCM 205 as well as other related control modules and circuitry for RESS 104 management, control, and diagnostics. The OBCM 203 may provide control signals 209 to the charge station 201, for example voltage and current settings, as well as charge limits and other parameters. The CCM 205 may provide control signals 211 to the converter 113, for example voltage and current settings. The battery manager module 114, including the OBCM 203 and the CCM 205, may receive inputs 207 directly from sensors, a vehicle bus such as a CAN bus, and communications from the charge station 201, the inputs including requests and data such as voltages and currents. Data available to the battery manager module 114 includes, but are not limited to, pack-A voltage VA, pack-B voltage VB, charge station voltage VC, charge station current IC, pack-A current IA, pack-B current IB, current into the converter IOUT, converter input voltage VOUT and converter output voltage VIN.

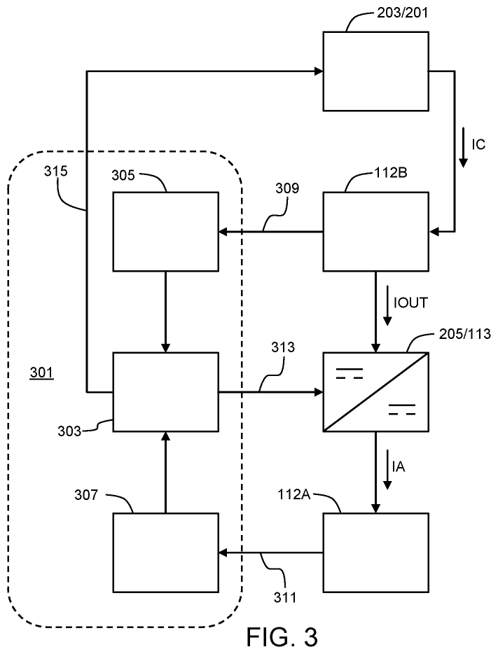

In an embodiment as depicted in FIG. 3, a simultaneous parallel charging control module (PCCM) 301 provides control signals 315 to the OBCM/charge station 203/201 and control signals 313 to the CCM/converter 205/113 to simultaneously charge a parallel combination of pack-A 112A and pack-B 112B coupled by a converter 113 as depicted in FIG. 2. The PCCM 301 may include a model predictive controller (MPC) 303 or other suitable controller for providing the control signals 315 and 313. Advantageously, the MPC 303 may be designed around differing constraints of each pack-A and pack-B to limit charge currents provided to each pack and allocate the charge station current IC between the packs in accordance with priority objectives. The control signals 315 may include settings for the charge station 201 desired voltage VCdes and/or desired current ICdes during a charge cycle which may include, for example, constant current (CC) modes and constant voltage (CV) modes. The control signals 313 may include settings for the converter 113 desired input current IOUTdes during a charge cycle which may include, for example, operating the converter in a CC mode or a CV mode. The PCCM 301 may include an observer 305 to estimate state of charge (SoC) and state of power (SoP) of pack-B and an observer 307 to estimate SoC and SoP of pack-A. The observers 305,307 receive respective inputs such as current, voltage and temperature corresponding to pack-A and pack-B (i.e., IA, VA, TA, IB, VB, TB). The SoC and SoP of pack-A and pack-B are provided as inputs to the MPC 303 for determining the settings for the desired input current IOUTdes and the settings for the charge station 201 desired voltage VCdes and/or desired current ICdes during a charge cycle including CC and CV modes. MPC 303 may operate within constraints based upon the SoP of pack-A and pack-B. An exemplary set of constraints for operating the converter 113 with priority charging first to pack-B may be represented in the following relationships:

$$( - {IB}_{max} + IC ) \frac{1}{p} \leq IOUT \leq ( - {IB}_{min} + IC ) \frac{1}{p} \qquad [ 1 ]$$

$$( {IA}_{min} ) \frac{VA}{pVB} \leq IOUT \leq ( {IA}_{max} ) \frac{VA}{pVB} \qquad [ 2 ]$$

where IBₘₐₓ is a maximum charge current limit of pack-B,
IBₘᵢₙ is a minimum charge current limit of pack-B,
IAₘₐₓ is a maximum charge current limit of pack-A,
IAₘᵢₙ is a minimum charge current limit of pack-A,
IOUT is the converter input current, and
p is the number of converters operated in parallel.

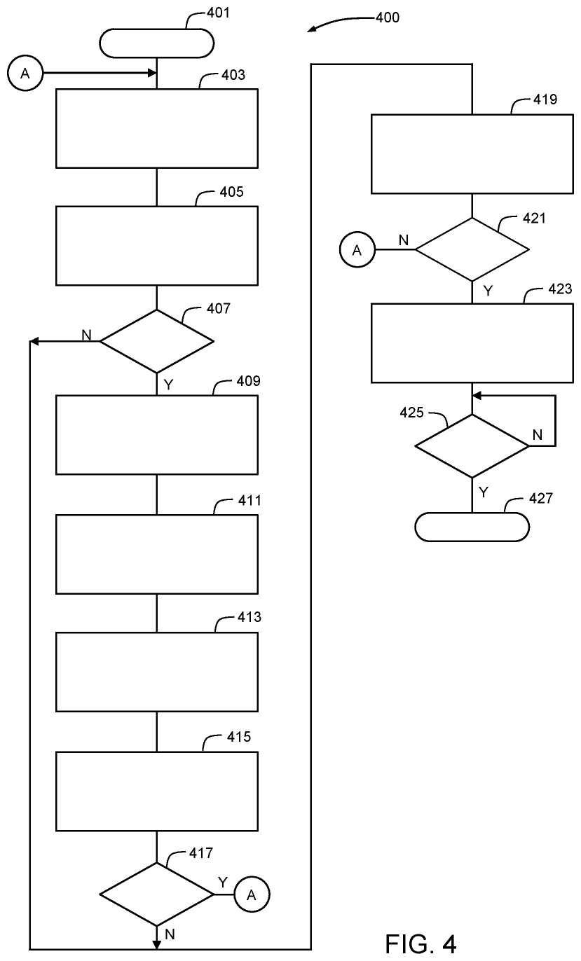

FIG. 4 is a process flow illustrating an exemplary implementation of a parallel charging routine 400 in accordance with an embodiment wherein pack-A 112A receives charging current through the converter 113 as depicted in FIGS. 2 and 3, and is the charging priority as between pack-A and pack-B. During ongoing vehicle operation, the routine 400 may be repetitively executed as part of an overall electrified vehicle 100 control. The routine 400 may represent routines and functions executed or performed, at least in part, by a processor or processors disposed in the electrified vehicle 100 of FIG. 1, including within one or more of the various controllers (e.g., 103, 114) and acting on or in conjunction with the various tangible hardware and devices including the electric propulsion system 101 described herein. The routine 400 may represent instruction sets stored in non-transitory memory and executed by the processor of one or more controllers. The routine 400 is illustrated with individual tasks and groups of tasks in a substantially linear fashion. One skilled in the art will understand that the routine 400 described may be represented in alternative ways including state flow diagrams and activity diagrams, for example. One skilled in the art also understands that the various tasks in the routine 400 may be implemented in different orders and/or simultaneously, and consolidated or split. The routine 400 may be discussed in conjunction with the electric propulsion system 101 of the exemplary electrified vehicle 100 of FIG. 1 and other FIGS. herein for illustration purposes.

The routine 400 initializes at 401 where the charging mode is initially set as a constant current mode. At 403, sensor and data inputs including VIN, VOUT, IA, IB, IOUT, IC, VC, and system temperatures may be ongoingly and regularly obtained, filtered, synchronized and otherwise processed for use in the present routine 400 among others. At 405, control quantities such as states, targets, limits and the like for use in control algorithms may be initially determined and ongoingly updated or adapted as required, for example through models, observers, and calibrations. For example, initial and target final values for SoC of each pack-A and pack-B may be determined and SoCs and SoPs ongoingly determined through observers 305, 307 as described herein with respect to FIG. 3. Decision block 407 routes to constant current (CC) Mode tasks beginning at 409 while the routine 400 is in the CC mode and routes to constant voltage (CV) mode tasks beginning at 419 while the routine 400 is in the CV mode.

In the CC mode, the target for pack-A current IA is determined and may be set in accordance with charge calibration profiles, pack-A temperature, SoC. SoP and other factors. An initial target may be set and subsequently updated during the CC mode. Since the target for pack-A current IA is provided by the converter 113, at 411 an equivalent power target for converter input current IOUT may be determined as IOUT=IA×(VIN/VOUT). Converter 113 limits, for example input current IOUT limits, if exceed by the equivalent target for converter input current IOUT may result in a converter 113 limited equivalent target for converter input current IOUT and effective reduction in the target for pack-A current IA. At 413, the power available from the charge station 201 is allocated with priority-first to pack-A through the converter input current IOUT and then to pack-B through the pack-B current IB. A target for pack-B current IB may be determined in a manner similar to the target for pack-A current IA. At 415, in the case where the charge station 201 power is sufficient to deliver a charge station current IC that is the sum of the target for converter input current IOUT and the target for pack-B current IB, then a charge station 201 current desired current ICdes may be set as the sum of the target for converter input current IOUT and the target for pack-B current IB and provided to the OBCM 203 for provision to the charge station 201 for implementation. However, in the case where the charge station 201 power is insufficient to deliver a charge station current IC that is the sum of the target for converter input current IOUT and the target for pack-B current IB, then the target for pack-B current IB is limited by the charge station 201 power limit. The charge station 201 desired current ICdes may therefore be set as the sum of the target for converter input current IOUT and the charge station 201 power limited target for pack-B current IB and provided to the OBCM 203 for provision to the charge station 201 for implementation. Also at 415, the converter 113 desired input current IOUTdes may be set to the target for converter input current IOUT as determined in the tasks at 411 and provided to the CCM 205 for controlling the converter 113 in a CC mode. As mentioned above with respect to the tasks at 409, the target for pack-A current IA may be adapted ongoingly during the CC mode. Thus, reductions in the target for pack-A current IA during the CC mode may free up charge station power for reallocation to pack-B via updated targets for pack-B current IB ongoingly during the CC mode. The decision block 417 determines whether the CC mode has completed, for example where pack-A 112A SoC has achieved some threshold value (e.g., 0.8). In the case where the CC mode has not completed, the decision block 417 returns to the tasks of 403 and 405 for updating sensor and control quantities and again to decision block 407 for routing to the active one of the CC mode tasks or the CV mode tasks. In the case where the CC mode has completed, the decision block 417 progresses the routine 400 to the CV mode tasks beginning at 419.

In the CV mode, at 419 the converter 113 may be controlled in a CV mode. The decision block 421 next determines whether the CV mode has completed with respect to the priority pack-A, for example where pack-A 112A SoC has achieved some final threshold value (e.g., 0.98). In the case where the CV mode has not completed, the decision block 421 returns to the tasks of 403 and 405 for updating sensor and control quantities and again to decision block 407 for routing to the active one of the CC mode tasks or the CV mode tasks. In the case where the CV mode has completed, the decision block 421 progresses the routine 400 to the tasks at 423 for turning off the converter 113 so no more charge current is delivered to pack-A. The converter 113 may be controlled off by the CCM 205 which may entail deactivating the converter power switches and opening bus contactors disconnecting the converter 113 at one or both of the converter input and output and isolating pack-A which is now deemed fully charged. The decision block 425 next determines whether the CV mode has completed with respect to the still actively charging pack-B, for example immediate completion regardless of SoC or determination based on metrics such as pack-B SoC achieving a final threshold value which may vary significantly based on such factors as initial SoC, current SoC, CC mode charge participation (i.e., was target charge current significantly limited due to charge station power limits?), or other factors. In the case where the CV mode has not completed, the decision block 425 waits for the completion as pack-B continues to charge in the CV mode. However, in the case where the CV mode has completed, the routine 400 ends at 427.

In an alternate embodiment of pack-A priority charging, in the case where the decision block 417 determines the CC mode has completed, the converter may be operated in a CV mode while the OBCM 203 continues to request CC mode charging from the charge station 201 based on a relatively slow time varying charge station 201 desired current ICdes as the sum of a substantially constant target for pack-B current IB and slowly declining converter input current IOUT corresponding to the slowly declining pack-A current IA through the CV mode operation of the converter 113.

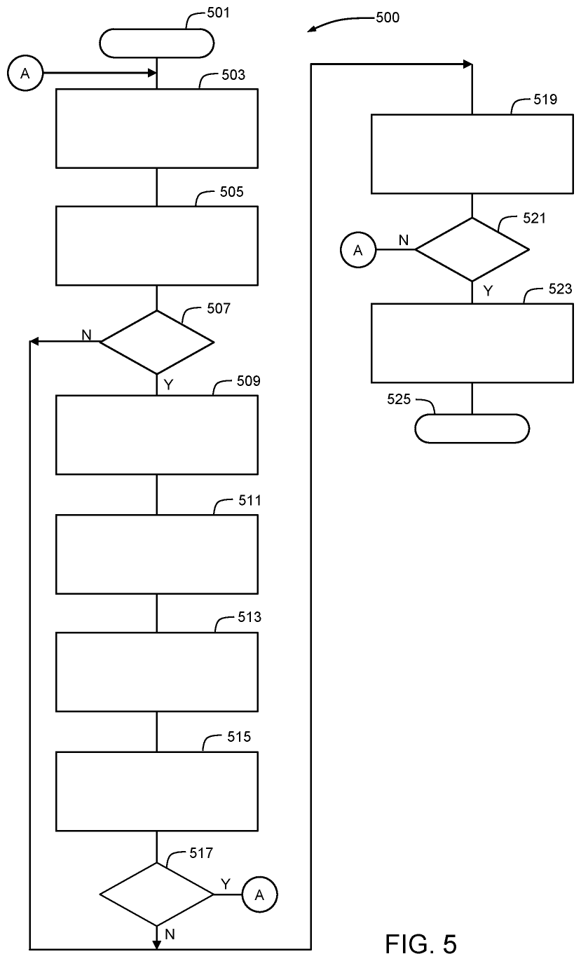

FIG. 5 is a process flow illustrating an exemplary implementation of a parallel charging routine 500 in accordance with an embodiment wherein pack-A 112A receives charging current through the converter 113 as depicted in FIGS. 2 and 3, and pack-B is the charging priority as between pack-A and pack-B. During ongoing vehicle operation, the routine 500 may be repetitively executed as part of an overall electrified vehicle 100 control. The routine 500 may represent routines and functions executed or performed, at least in part, by a processor or processors disposed in the electrified vehicle 100 of FIG. 1, including within one or more of the various controllers (e.g., 103, 114) and acting on or in conjunction with the various tangible hardware and devices including the electric propulsion system 101 described herein. The routine 500 may represent instruction sets stored in non-transitory memory and executed by the processor of one or more controllers. The routine 500 is illustrated with individual tasks and groups of tasks in a substantially linear fashion. One skilled in the art will understand that the routine 500 described may be represented in alternative ways including state flow diagrams and activity diagrams, for example. One skilled in the art also understands that the various tasks in the routine 500 may be implemented in different orders and/or simultaneously, and consolidated or split. The routine 500 may be discussed in conjunction with the electric propulsion system 101 of the exemplary electrified vehicle 100 of FIG. 1 and other FIGS. herein for illustration purposes.

The routine 500 initializes at 501 where the charging mode is initially set as a constant current mode. At 503, sensor and data inputs including VIN, VOUT, IA, IB, IOUT, IC, VC, and system temperatures may be ongoingly and regularly obtained, filtered, synchronized and otherwise processed for use in the present routine 500 among others. At 505, control quantities such as states, targets, limits and the like for use in control algorithms may be initially determined and ongoingly updated or adapted as required, for example through models, observers, and calibrations. For example, initial and target final values for SoC of each pack-A and pack-B may be determined and SoCs and SoPs ongoingly determined through observers 305, 307 as described herein with respect to FIG. 3. Decision block 507 routes to constant current (CC) Mode tasks beginning at 509 while the routine 500 is in the CC mode and routes to constant voltage (CV) mode tasks beginning at 519 while the routine 500 is in the CV mode.

In the CC mode, the target for pack-B current IB is determined and may be set in accordance with charge calibration profiles, pack-B temperature, SoC, SoP and other factors. An initial target may be set and subsequently updated during the CC mode. At 511, the power available from the charge station 201 is allocated with priority-first to pack-B through the pack-B current IB and then to pack-A through the converter input current IOUT. A target for pack-A current IA may be determined in a manner similar to the target for pack-B current IB. Since the target for pack-A current IA is provided by the converter 113, at 513 an equivalent power target for converter input current IOUT may be determined as IOUT=IA×(VIN/VOUT). Converter 113 limits, for example input current IOUT limits, if exceed by the equivalent target for converter input current IOUT may result in a converter 113 limited equivalent target for converter input current IOUT and effective reduction in the target for pack-A current IA. At 515, in the case where the charge station 201 power is sufficient to deliver a charge station current IC that is the sum of the target for converter input current IOUT and the target for pack-B current IB, then a charge station 201 current desired current ICdes may be set as the sum of the target for converter input current IOUT and the target for pack-B current IB and provided to the OBCM 203 for provision to the charge station 201 for implementation. However, in the case where the charge station 201 power is insufficient to deliver a charge station current IC that is the sum of the target for converter input current IOUT and the target for pack-B current IB, then the target for pack-A current IA is limited by the charge station 201 power limit and the corresponding target for converter input current IOUT is adjusted accordingly. The charge station 201 desired current ICdes may therefore be set as the sum of the adjusted target for converter input current IOUT and the target for pack-B current IB and provided to the OBCM 203 for provision to the charge station 201 for implementation. Also at 515, the converter 113 desired input current IOUTdes may be set to the target for converter input current IOUT as determined in the tasks at 513 and provided to the CCM 205 for controlling the converter 113 in a CC mode. As mentioned above with respect to the tasks at 509, the target for pack-B current IB may be adapted ongoingly during the CC mode. Thus, reductions in the target for pack-B current IB during the CC mode may free up charge station power for reallocation to pack-A via updated targets for pack-A current IA (and corresponding target for converter input current IOUT) ongoingly during the CC mode. The decision block 517 determines whether the CC mode has completed, for example where pack-B 112B SoC has achieved some threshold value (e.g., 0.8). In the case where the CC mode has not completed, the decision block 517 returns to the tasks of 503 and 505 for updating sensor and control quantities and again to decision block 507 for routing to the active one of the CC mode tasks or the CV mode tasks. In the case where the CC mode has completed, the decision block 517 progresses the routine 500 to the CV mode tasks beginning at 519.

In the CV mode, at 519 the converter 113 may be controlled in a CV mode. The decision block 521 next determines whether the CV mode has completed with respect to the priority pack-B, for example where pack-B 112B SoC has achieved some final threshold value (e.g., 0.98). In the case where the CV mode has not completed, the decision block 521 returns to the tasks of 503 and 505 for updating sensor and control quantities and again to decision block 507 for routing to the active one of the CC mode tasks or the CV mode tasks. In the case where the CV mode has completed, the decision block 521 progresses the routine 500 to the tasks at 523 for turning off the converter 113 so no more charge current is delivered to pack-A. The converter 113 may be controlled off by the CCM 205 which may entail deactivating the converter power switches and opening bus contactors disconnecting the converter 113 at one or both of the converter input and output and isolating pack-A. The CV mode is deemed complete based on pack-B completion and the routine 500 ends at 525.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof.

All numeric values herein are assumed to be modified by the term “about” whether or not explicitly indicated. For the purposes of the present disclosure, ranges may be expressed as from “about” one particular value to “about” another particular value. The term “about” generally refers to a range of numeric values that one of skill in the art would consider equivalent to the recited numeric value, having the same function or result, or reasonably within manufacturing tolerances of the recited numeric value generally. Similarly, numeric values set forth herein are by way of non-limiting example and may be nominal values, it being understood that actual values may vary from nominal values in accordance with environment, design and manufacturing tolerance, age and other factors.

When an element such as a layer, film, region, or substrate is referred to as being “on” another element, it can be directly on the other element or intervening elements may also be present. In contrast, when an element is referred to as being “directly on” another element, there are no intervening elements present. Therefore, unless explicitly described as being “direct,” when a relationship between first and second elements is described in the above disclosure, that relationship may be a direct relationship where no other intervening elements are present between the first and second elements but may also be an indirect relationship where one or more intervening elements are present (either spatially or functionally) between the first and second elements.

One or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Unless defined otherwise, technical and scientific terms used herein have the same meaning as is commonly understood by one of skill in the art to which this disclosure belongs.

Unless specified to the contrary herein, all test standards are the most recent standard in effect as of the filing date of this application, or, if priority is claimed, the filing date of the earliest priority application in which the test standard appears.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A method of controlling simultaneous parallel charging of a first electrical energy storage devices (ESD) and a second ESD from a charge source, comprising:
coupling the charge source directly to one of the first ESD and the second ESD and through a direct current to direct current (DC to DC) converter to the other of the first ESD and the second ESD;
determining a first current for charging the first ESD;
determining a second current for charging the second ESD;
when the charge source cannot simultaneously provide the first current and the second current without violating a charge source constraint, determining a reduced second current for charging the second ESD wherein the charge source can simultaneously provide the first current and the reduced second current without violating the charge source constraint; and
allocating the first current to the first ESD and the reduced second current to the second ESD by controlling the DC to DC converter.

2. The method of claim 1, wherein the charge source is coupled directly to the first ESD and through the DC to DC converter to the second ESD.

3. The method of claim 1, wherein the charge source is coupled directly to the second ESD and through the DC to DC converter to the first ESD.

4. A charge apparatus for a rechargeable energy storage system (RESS), comprising:
a charge source;
a DC to DC converter;
a first energy storage device (ESD);
a second ESD;
the charge source coupled directly to one of the first ESD and the second ESD and through the DC to DC converter to the other of the first ESD and the second ESD;
a controller:
determining a first current for charging the first ESD;
determining a second current for charging the second ESD;
when the charge source cannot simultaneously provide the first current and the second current without violating a charge source constraint, determining a reduced second current for charging the second ESD wherein the charge source can simultaneously provide the first current and the reduced second current without violating the charge source constraint; and
allocating the first current to the first ESD and the reduced second current to the second ESD by controlling the DC to DC converter.

5. The charge apparatus of claim 4 wherein the charge source comprises an infrastructure charge station.

6. The charge apparatus of claim 4 wherein the charge source comprises a donor vehicle.

7. The charge apparatus of claim 4 wherein the first ESD and the second ESD comprise batteries.

8. The charge apparatus of claim 4 wherein at least one of the first ESD and the second ESD comprises a supercapacitor.

9. The charge apparatus of claim 4 wherein the DC to DC converter comprises a boost converter.

10. The charge apparatus of claim 4 wherein the DC to DC converter comprises a buck converter.

11. The charge apparatus of claim 4 wherein the DC to DC converter comprises a buck/boost converter.

12. The charge apparatus of claim 4 wherein the charge source is coupled directly to the first ESD and through the DC to DC converter to the second ESD.

13. The charge apparatus of claim 4 wherein the charge source is coupled directly to the second ESD and through the DC to DC converter to the first ESD.

14. An electrified powertrain for a vehicle, comprising:
a rechargeable energy storage system (RESS) including a first energy storage device (ESD) and a second ESD;
an electric drive unit (EDU);
a DC to DC converter; and
a controller:
determining a first current for charging the first ESD;
determining a second current for charging the second ESD;
when a charge source that is coupled directly to one of the first ESD and the second ESD and through the DC to DC converter to the other of the first ESD and the second ESD cannot simultaneously provide the first current and the second current without violating a charge source constraint, determining a reduced second current for charging the second ESD wherein the charge source can simultaneously provide the first current and the reduced second current without violating the charge source constraint; and
allocating the first current to the first ESD and the reduced second current to the second ESD by controlling the DC to DC converter.

15. The electrified powertrain of claim 14 wherein the first ESD and the second ESD comprise batteries.

16. The electrified powertrain of claim 14 wherein at least one of the first ESD and the second ESD comprises a supercapacitor.

17. The electrified powertrain of claim 14 wherein the DC to DC converter comprises one of a boost converter and a buck converter.

18. The electrified powertrain of claim 14 wherein the DC to DC converter comprises a buck/boost converter.

19. The electrified powertrain of claim 14 wherein the charge source is coupled directly to the first ESD and through the DC to DC converter to the second ESD.

20. The electrified powertrain of claim 14 wherein the charge source is coupled directly to the second ESD and through the DC to DC converter to the first ESD.
